(19) United States
(12) Patent Application Publication
(10) Pub. No.: US 2017/0046044 A1
(43) Pub. Date: Feb. 16, 2017

(54) DISPLAY CONTROL METHOD AND ELECTRONIC DEVICE

(71) Applicants: Beijing Lenovo Software Ltd., Beijing (CN); Lenovo (Beijing) Limited, Beijing (CN)

(72) Inventor: Zhongquan Sun, Beijing (CN)

(21) Appl. No.: 14/982,357

(22) Filed: Dec. 29, 2015

(30) Foreign Application Priority Data
Aug. 10, 2015 (CN) 201510486143.2

(51) Int. Cl. G06F 3/0481; G06F 3/0482

(52) U.S. Cl. CPC G06F 3/04817; G06F 3/0482

(57) ABSTRACT

The present disclosure discloses a display control method and an electronic device. The method comprises: acquiring a preview instruction for a new desktop theme; and in response to the preview instruction, acquiring a theme data package of the new desktop theme; acquiring at least one icon carried on a desktop interface which is currently displayed on a display screen of an electronic device; and temporarily changing, based on the theme data package of the new desktop theme, a body which carries the at least one icon from a first identification picture to a second identification picture.

### CROSS-REFERENCE TO RELATED APPLICATION(S)

This application claims priority to the Chinese Patent Application No. 201510486143.2, filed on Aug. 10, 2015, entitled “DISPLAY CONTROL METHOD AND ELECTRONIC DEVICE” which is incorporated herein by reference in its entirety.

### TECHNICAL FIELD

The present disclosure relates to electronic technology, and more particularly, to a display control method and an electronic device.

### BACKGROUND

Currently, a user can only preview a picture which is made by a theme change application for a specific theme, but cannot preview the picture based on a current desktop and icons on the desktop. In this case, the user can only determine whether the desktop theme is suitable after the desktop theme is used, and if it is not suitable, the user needs to execute the theme change application again to select a new theme and use the new theme. Thus, a theme which is suitable for the current desktop and the icons on the desktop might not be found by the user until the above process has been performed for a number of times.

### SUMMARY

In view of this, in order to solve the technical problem in the related art, embodiments of the present disclosure provide a display control method and an electronic device.

The technical solutions according to the embodiments of the present disclosure can be achieved as follows.

In a first aspect, the embodiments of the present disclosure provide a display control method, comprising: acquiring a preview instruction for a new desktop theme: and in response to the preview instruction, acquiring a theme data package of the new desktop theme, acquiring at least one icon carried on a desktop interface which is currently displayed on a display screen of an electronic device, and temporarily changing, based on the theme data package of the new desktop theme, a body which carries the at least one icon from a first identification picture to a second identification picture.

In a second aspect, the embodiments of the present disclosure provide an electronic device, comprising a display screen and a processor, wherein the display screen is configured to display a desktop interface; and the processor is configured to acquire a preview instruction for a new desktop theme; and in response to the preview instruction, acquire a theme data package of the new desktop theme, acquire at least one icon carried on a desktop interface which is currently displayed on the display screen of the electronic device, and temporarily change, based on the theme data package of the new desktop theme, a body which carries the at least one icon from a first identification picture to a second identification picture.

In the embodiments of the present disclosure, a preview instruction for a new desktop theme is acquired; and in response to the preview instruction, a theme data package of the new desktop theme is acquired, at least one icon carried on a desktop interface which is currently displayed on a display screen of an electronic device is acquired, and a body which carries the at least one icon is temporarily changed from a first identification picture to a second identification picture based on the theme data package of the new desktop theme. In this way, a preview operation can be performed based on a current desktop and icons on the desktop, so that a user can conveniently find a theme suitable for the current desktop and the icons on the desktop, thereby simplifying the operation and improving efficiency.

### BRIEF DESCRIPTION OF THE DRAWINGS

FIG. 1 is a flowchart of a display control method according to a first embodiment of the present disclosure;

FIG. 2 is a flowchart of step 102 in the display control method according to the first embodiment of the present disclosure;

FIG. 3 is a flowchart of a display control method according to a second embodiment of the present disclosure;

FIG. 4 is a flowchart of step 303 in the display control method according to the second embodiment of the present disclosure;

FIG. 5 is a diagram of a scenario where a display control method according to an embodiment of the present disclosure is used;

FIG. 6 is a diagram of another scenario where a display control method according to an embodiment of the present disclosure is used;

FIG. 7 is a flowchart of a display control method according to a third embodiment of the present disclosure;

FIG. 8 is a flowchart of a display control method according to a fourth embodiment of the present disclosure;

FIG. 9 is a diagram of a further scenario where a display control method according to an embodiment of the present disclosure is used; and

FIG. 10 is a block diagram of display control apparatus according to a fifth embodiment of the present disclosure.

### DETAILED DESCRIPTION

The technical solutions according to the present disclosure will be further described in detail below in conjunction with accompanying drawings and specific embodiments.

### First Embodiment

The embodiment of the present disclosure provides a display control method applied in an electronic device. Functions of the display control method may be implemented by a processor in the electronic device invoking program codes. The program codes may be stored in a computer storage medium. Thus, the electronic device includes at least a processor and a storage medium.

The electronic device in the present embodiment may be a Personal Computer (PC) which is a stationary electronic device, or a Personal Digital Assistant (PDA), a table computer, or a notebook computer which is a portable electronic device. The electronic device may also be an intelligent mobile terminal such as smart phone.

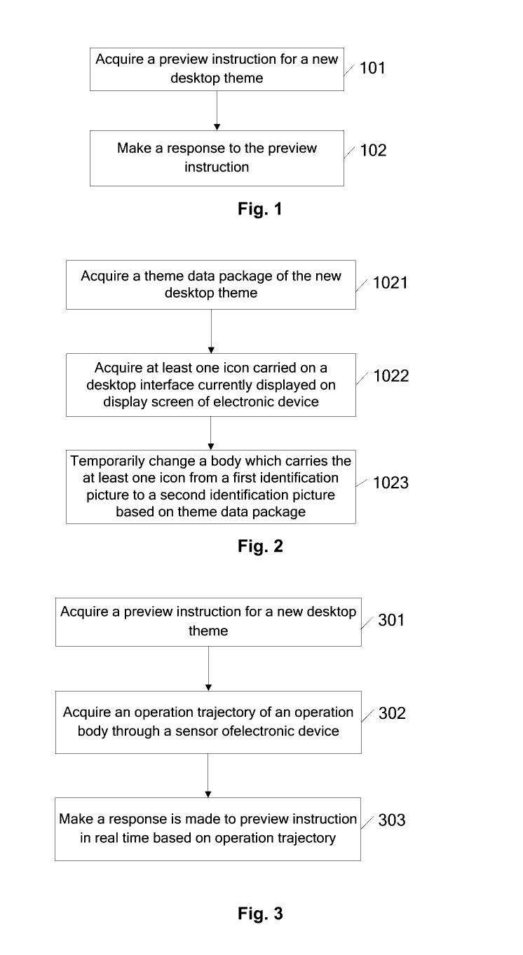

FIG. 1 is a flowchart of a display control method according to a first embodiment of the present disclosure. As shown in FIG. 1, the display control method comprises the following steps.

In step 101, a preview instruction for a new desktop theme is acquired.

It should be noted herein that the preview instruction in the present embodiment may be generated in different manners depending on the type of the electronic device. For example, when the electronic device is a conventional personal computer and an input device is a mouse, the preview instruction may be acquired by a user clicking on a display screen with the mouse. When a display device of the electronic device (for example, an smart mobile phone, a tablet computer, a desktop computer which uses a touch display screen) is a touch display screen, the preview instruction may be acquired through a touch operation implemented by an operation body which may be a finger, a stylus or the like. It should be illustrated that the manner in which the preview instruction is generated may be defined by those skilled in the art. For example, the preview instruction may be generated by a user clicking on a key with a mouse to specify and trigger the key, or the preview instruction may be generated by a user touching a specified region of an interface with a finger to specify and trigger a key. In a specific implementation, the present disclosure is not limited to the manners according to the embodiment of the present disclosure. The preview instruction may also be acquired by those skilled in the art in various conventional manners, which therefore will not be described herein. It can be seen from the above description that in addition to the display screen, the electronic device further comprises an input device, and when the electronic device uses a touch display screen (a touch screen), the input device and the display screen of the electronic device are integrated as a whole.

In step 102, a response is made to the preview instruction.

Specifically, as shown in FIG. 2, making a response to the preview instruction in step 102 comprises the following steps.

In step 1021, a theme data package of the new desktop theme is acquired.

Here, in the present embodiment, each desktop theme has a theme data package. The theme data package comprises various parameters and data required for configuration of the desktop theme.

In step 1022, at least one icon carried on a desktop interface which is currently displayed on a display screen of an electronic device is acquired.

In step 1023, a body which carries the at least one icon is temporarily changed from a first identification picture to a second identification picture based on the theme data package of the new desktop theme.

The first identification picture is different from the second identification picture herein.

In order to facilitate the preview based on the current desktop and icons on the desktop, the body which carries the at least one icon is temporarily changed from the first identification picture to the second identification picture, so as to determine whether the new desktop theme is suitable for the current desktop and the icons on the desktop.

In practical applications, the step 1021 and the step 1022 may be performed in any order, i.e., an order of acquiring a theme data package and acquiring at least one icon is not limited herein.

In practical applications, the method may further comprise temporarily changing, based on the theme data package of the new desktop theme, a shape of the body which carries the at least one icon. For example, a body which carries an original desktop theme is in a circular shape, and a body which carries the new desktop theme is changed to a rectangular shape.

In practical applications, the method may further comprise temporarily changing, based on the theme data package of the new desktop theme, a background picture of the body which carries the at least one icon.

### Second Embodiment

Based on the above embodiment, the embodiment of the present disclosure provides a display control method applied in an electronic device. Functions of the display control method may be implemented by a processor in the electronic device invoking program codes. The program codes may be stored in a computer storage medium. Thus, the electronic device includes at least a processor and a storage medium.

FIG. 3 is a flowchart of a display control method according to a second embodiment of the present disclosure. As shown in FIG. 3, the display control method comprises the following steps.

In step 301, a preview instruction for a new desktop theme is acquired.

In step 302, an operation trajectory of an operation body is acquired through a sensor of the electronic device.

In the present embodiment, a touch display screen (a touch screen) may be used as a sensor.

The operation trajectory of the operation body may be a trajectory produced by a user's finger sliding on a touch screen.

In step 303, a response is made to the preview instruction in real time based on the operation trajectory.

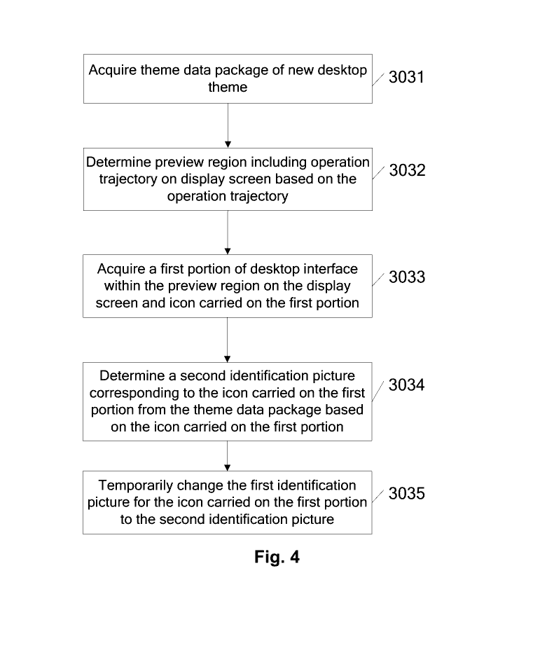

Specifically, as shown in FIG. 4, making a response to the preview instruction in real time based on the operation trajectory in step 303 comprises the following steps.

In step 3031, a theme data package of the new desktop theme is acquired.

In step 3032, a preview region including the operation trajectory on the display screen is determined based on the operation trajectory.

In step 3033, a first portion of the corresponding desktop interface within the preview region on the display screen and an icon carried on the first portion are acquired.

In step 3034, the second identification picture corresponding to the icons carried on the first portion is determined from the theme data package based on the icon carried on the first portion.

In step 3035, the first identification picture for the icons carried on the first portion is temporarily changed to the second identification picture.

The first portion of the desktop interface and the icon carried on the first portion have a preview display effect of the new desktop theme, and a second portion of the desktop interface except for the first portion and icons carried on the second portion have a display effect of an old desktop theme which is different from the new desktop theme.

It should be pointed out herein that the preview display effect of the new desktop theme is also different from the display effect of the old desktop theme.

In practical applications, the method may further comprise temporarily changing, based on the theme data package of the new desktop theme, a background picture of the first portion.

The embodiment of the present disclosure will be described below in conjunction with a specific application scenario.

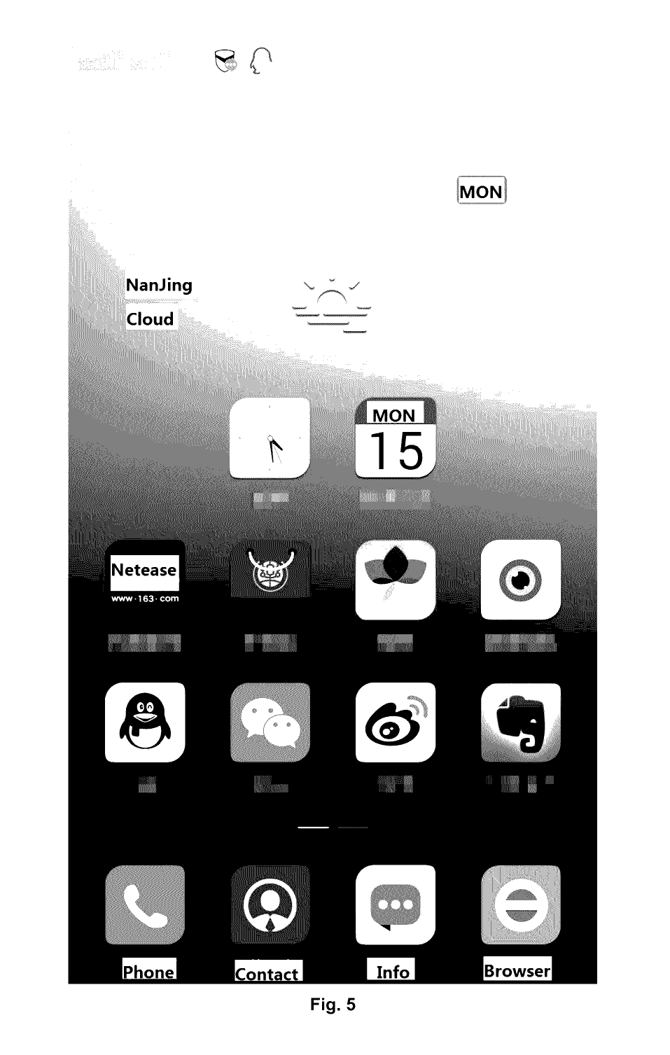

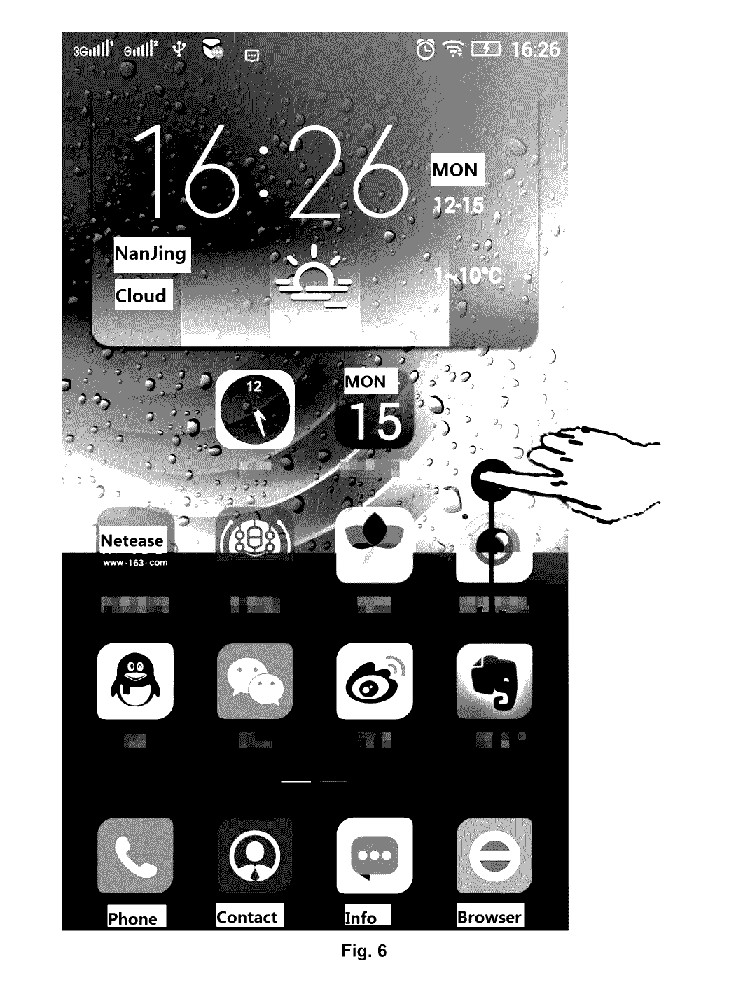

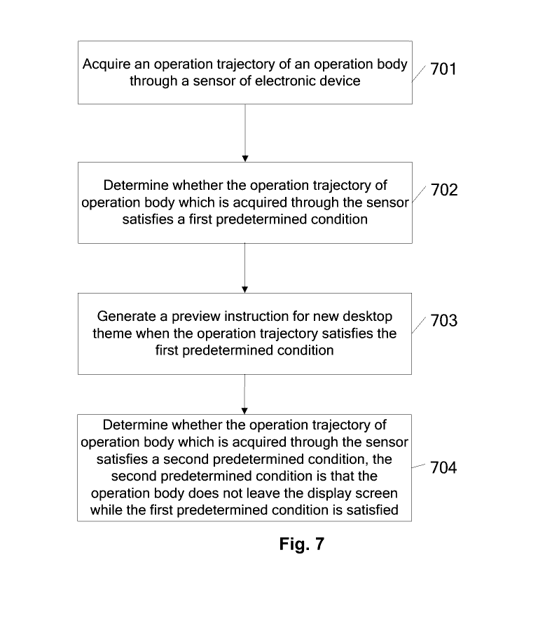

FIG. 5 illustrates a desktop interface which is currently displayed on a display screen of an electronic device. In practical applications, a new desktop theme enters the display screen based on a preview instruction, and as a finger slides, the new desktop theme gradually covers a region of the screen where the finger slides, as shown in FIG. 6. FIG. 6 is merely an example, and a direction in which the finger slides, a region where the finger slides or the like are not limited in the present embodiment. In practical applications, the finger may also slide horizontally, diagonally, or in a direction from bottom to top within the touch screen. It is easily reached that in practical applications, an effective region may also be set in the touch screen, and a sliding trajectory is effective only in the effective region.

Specifically, a body which carries icons within a region where a finger slides is temporarily changed from a first identification picture to a second identification picture based on the theme data package of the new desktop theme.

The method may further comprise changing, based on the theme data package of the new desktop theme, a shape of the body which carries the icons within the region where the finger slides.

In practical applications, the old desktop theme may be maintained in a region of the screen where the finger does not slide. In this way, the display effects of the new desktop theme and the old desktop theme may be compared by a user, so as to select a suitable desktop theme.

It should be pointed out herein that if the operation body leaves before arriving at a specified position, the preview instruction is no longer performed, and the first identification picture for the icons is recovered at this time. In this way, when the user is not satisfied with the previewed new desktop theme, the preview operation may be stopped at any time. Then, another new desktop theme may be previewed again.

### Third Embodiment

Based on the above embodiments, the embodiment of the present disclosure provides a display control method applied in an electronic device. Functions of the display control method may be implemented by a processor in the electronic device invoking program codes. The program codes may be stored in a computer storage medium. Thus, the electronic device includes at least a processor and a storage medium.

FIG. 7 is a flowchart of a display control method according to a third embodiment of the present disclosure. As shown in FIG. 7, the display control method comprises the following steps.

In step 701, an operation trajectory of an operation body is acquired through a sensor of the electronic device.

In step 702, it is determined whether the operation trajectory of the operation body which is acquired through the sensor of the electronic device satisfies a first predetermined condition.

In step 703, the preview instruction for the new desktop theme is generated when the operation trajectory satisfies the first predetermined condition.

Here, the first predetermined condition may be a condition that a specified sliding manner is performed in a specified region or the like.

In step 704, it is determined whether the operation trajectory of the operation body which is acquired through the sensor of the electronic device satisfies a second predetermined condition, wherein the second predetermined condition is a condition that the operation body does not leave the display screen while the first predetermined condition is satisfied.

It should be pointed out herein that if the operation body leaves before arriving at a specified position, the preview instruction is no longer performed, and the first identification picture for the icons is recovered at this time. In this way, when the user is not satisfied with the previewed new desktop theme, the preview operation may be stopped at any time. Then, another new desktop theme may be previewed again.

### Fourth Embodiment

Based on the above embodiments, the embodiment of the present disclosure provides a display control method applied in an electronic device. Functions of the display control method may be implemented by a processor in the electronic device invoking program codes. The program codes may be stored in a computer storage medium. Thus, the electronic device includes at least a processor and a storage medium.

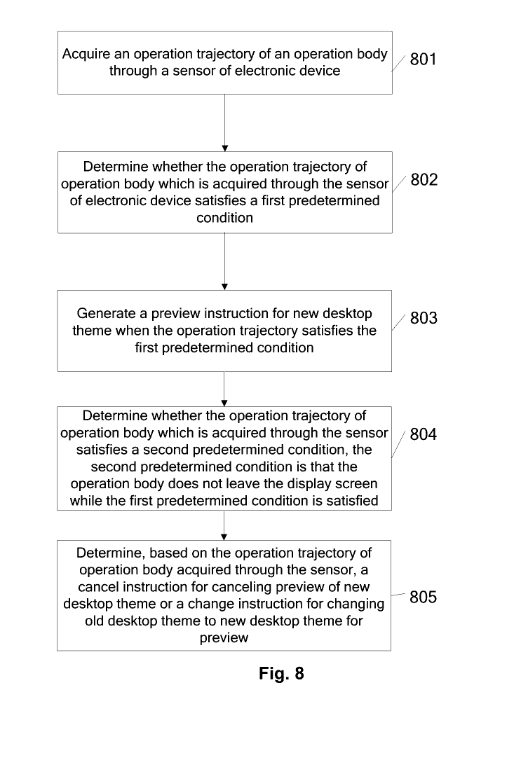

FIG. 8 is a flowchart of an implementation of a display control method according to a fourth embodiment of the present disclosure. As shown in FIG. 8, the display control method comprises the following steps.

In step 801, an operation trajectory of an operation body is acquired through a sensor of the electronic device.

In step 802, it is determined whether the operation trajectory of the operation body which is acquired through the sensor of the electronic device satisfies a first predetermined condition.

In step 803, the preview instruction for the new desktop theme is generated when the operation trajectory satisfies the first predetermined condition.

In step 804, it is determined whether the operation trajectory of the operation body which is acquired through the sensor of the electronic device satisfies a second predetermined condition, wherein the second predetermined condition is a condition that the operation body does not leave the display screen while the first predetermined condition is satisfied.

In step 805, it is determined, based on the operation trajectory of the operation body which is acquired through the sensor of the electronic device, a cancel instruction for canceling preview of the new desktop theme or a change instruction for changing the old desktop theme to the new desktop theme for preview.

Step 805 further includes determining whether the operation trajectory satisfies a third predetermined condition: generating the cancel instruction when the operation trajectory does not satisfy the third predetermined condition, and generating the change instruction when the operation trajectory satisfies the third predetermined condition.

The third predetermined condition is a condition that operation parameters generated by the operation body when the operation body leaves the display screen satisfy a particular condition while the first predetermined condition is satisfied.

It should be noted herein that the particular condition may comprise a condition that a position where the operation body leaves is in a particular region, for example, at the bottom of the screen; a condition that a distance of the operation trajectory generated by the operation body when the operation body leaves is approximately equal to that of a long side of the display screen; a condition that the position where the operation body leaves is lower than the lowest row of icons on the desktop, or the like.

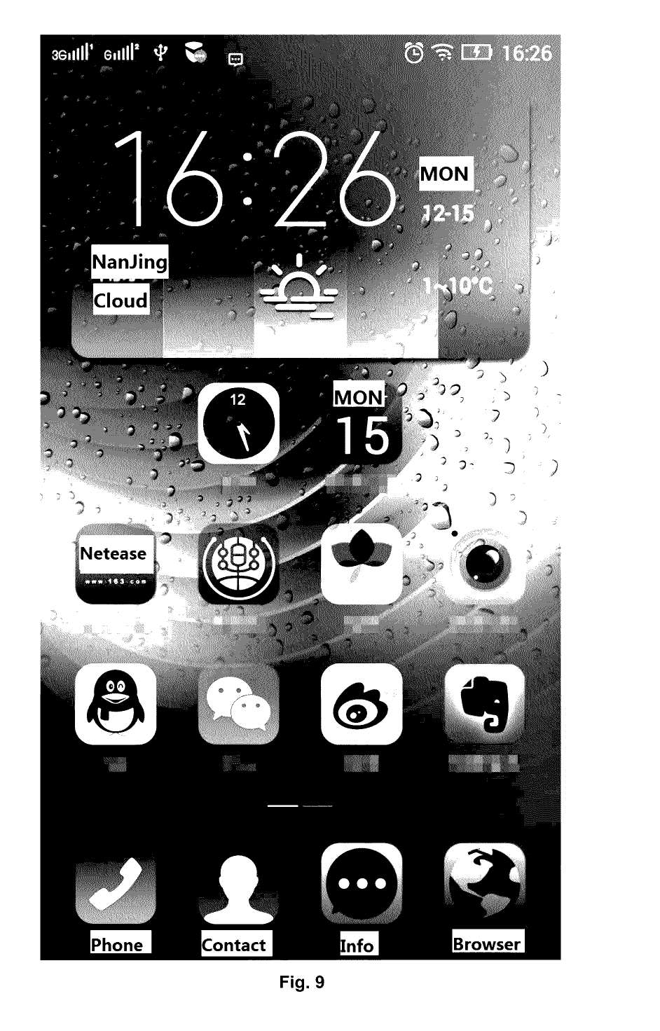

FIG. 9 illustrates a desktop interface in which an old desktop theme is changed to a new desktop theme. After a user comprehensively previews a display effect of changing the old desktop theme to the new desktop theme, if the user is satisfied with the display effect, the operation body of the user may leave from a particular region. In this way, the old desktop theme is directly changed to the new desktop theme, which is convenient for change of a desktop theme.

In practical applications, a first background sound may be made when a finger slides, and a second background sound may be made when the finger arrives in a particular region, so as to prompt the user that the finger may be released to change the desktop theme.

### Fifth Embodiment

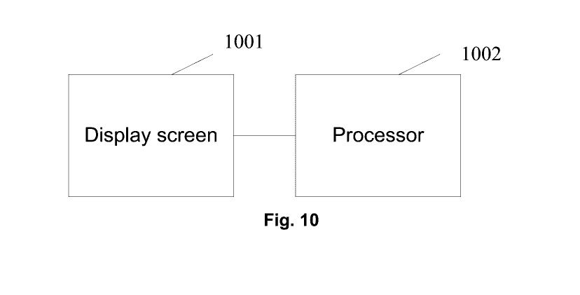

Based on the above embodiments, the embodiment of the present disclosure provides an electronic device. As shown in FIG. 10, the electronic device comprises a display screen 1001 and a processor 1002.

The display screen 1001 is configured to display a desktop interface.

The processor 1002 is configured to acquire a preview instruction for a new desktop theme; and in response to the preview instruction, acquire a theme data package of the new desktop theme, acquire at least one icon carried on a desktop interface which is currently displayed on the display screen of the electronic device, and temporarily change, based on the theme data package of the new desktop theme, a body which carries the at least one icon from a first identification picture to a second identification picture.

It is easily reached that in the process of implementing a specific embodiment, the processor may be a Central Processing Unit (CPU), a Micro Processing Unit (MPU), a Digital Signal Processor (DSP), a Field Programmable Gate Array (FPGA) or the like.

The first identification picture is different from the second identification picture herein.

In order to facilitate preview based on the current desktop and icons on the desktop, the body which carries the at least one icon is temporarily changed from the first identification picture to the second identification picture, so as to determine whether the new desktop theme is suitable for the current desktop and the icons on the desktop.

In practical applications, the processor may further be configured to temporarily change, based on the theme data package of the new desktop theme, a shape of the body which carries the at least one icon. For example, a body which carries an original desktop theme is in a circular shape, and a body which carries the new desktop theme is changed to a rectangular shape.

In practical applications, the processor may further be configured to temporarily change, based on the theme data package of the new desktop theme, a background picture of the body which carries the at least one icon, for example, a desktop wallpaper.

It should be pointed out herein that the apparatus embodiment above has similar description to that of the method embodiment above, has a similar beneficial effect to that of the method embodiment, and therefore will not be described. The technical details which are not disclosed in the apparatus embodiment of the present disclosure can be understood with reference to the description of the method embodiment of the present disclosure, and will not be described for brevity.

### Sixth Embodiment

Based on the above embodiments, the embodiment of the present disclosure further provides a display control apparatus that includes a display screen and a processor.

The display screen is configured to display a desktop interface.

The processor is configured to acquire a preview instruction for a new desktop theme: acquire an operation trajectory of an operation body through a sensor of an electronic device, and make a response to the preview instruction in real time based on the operation trajectory.

In the present embodiment, the display screen may be a touch display screen (a touch screen).

It is easily reached that in the process of implementing a specific embodiment, the processor may be a CPU, an MPU, a DSP, a FPGA or the like.

It should be pointed out herein that the apparatus embodiment above has similar description to that of the method embodiment above, has a similar beneficial effect to that of the method embodiment, and therefore will not be described. The technical details which are not disclosed in the apparatus embodiment of the present disclosure can be understood with reference to the description of the method embodiment of the present disclosure, and will not be described for brevity.

### Seventh Embodiment

Based on the above embodiments, the embodiment of the present disclosure further provides a display control apparatus that includes a display screen and a processor.

The display screen is configured to display a desktop interface.

The processor is configured to acquire a preview instruction for a new desktop theme; acquiring an operation trajectory of an operation body through a sensor of an electronic device, make a response to the preview instruction in real time based on the operation trajectory; acquire a theme data package of the new desktop theme; determine a preview region including the operation trajectory on the display screen based on the operation trajectory, acquire a first portion of the corresponding desktop interface on the display screen within the preview region and icons carried on the first portion, determine, based on the icons carried on the first portion, the second identification picture corresponding to the icons carried on the first portion from the theme data package, and temporarily change the first identification picture for the icons carried on the first portion to the second identification picture.

The first portion of the desktop interface and the icons carried on the first portion have a preview display effect of the new desktop theme, and a second portion of the desktop interface except for the first portion and icons carried on the second portion have a display effect of an old desktop theme which is different from the new desktop theme.

The embodiment of the present disclosure will be described below in conjunction with a specific application scenario.

FIG. 5 illustrates a desktop interface which is currently displayed on a display screen of an electronic device. In practical applications, a new desktop theme enters the display screen based on a preview instruction, and as a finger slides, the new desktop theme gradually covers a region of the screen where the finger slides, as shown in FIG. 6. FIG. 6 is merely an example, and a direction in which the finger slides, a region where the finger slides or the like are not limited in the present embodiment. In practical applications, the finger may also slides vertically, horizontally, diagonally, or in a direction from bottom to top or from left to right or from right to left within the touch screen. It is easily reached that in practical applications, an effective region may also be set in the touch screen, and the sliding trajectory is effective only in the effective region.

Specifically, a body which carries icons within a region where a finger slides is temporarily changed from a first identification picture to a second identification picture based on the theme data package of the new desktop theme.

A shape of the body which carries the icons within the region where the finger slides may further be temporarily changed based on the theme data package of the new desktop theme.

In practical applications, the old desktop theme may be maintained in a region of the screen where the finger does not slide. In this way, the display effects of the new desktop theme and the old desktop theme may be compared by a user, so as to select a suitable desktop theme.

It should be pointed out herein that if the operation body leaves before arriving at a specified position, the preview instruction is no longer performed, and the first identification picture for the icons is recovered at this time. In this way, when the user is not satisfied with the previewed new desktop theme, the preview operation may be stopped at any time. Then, another new desktop theme may be previewed again.

It is easily reached that in the process of implementing a specific embodiment, the processor may be a CPU, an MPU, a DSP, a FPGA or the like.

It should be pointed out herein that the apparatus embodiment above has similar description to that of the method embodiment above, has a similar beneficial effect to that of the method embodiment, and therefore will not be described. The technical details which are not disclosed in the apparatus embodiment of the present disclosure can be understood with reference to the description of the method embodiment of the present disclosure, and will not be described for brevity.

### Eighth Embodiment

Based on the above embodiments, the embodiment of the present disclosure further provides a display control apparatus that includes a display screen and a processor.

The display screen is configured to display a desktop interface.

The processor is configured to acquire an operation trajectory of an operation body through a sensor of an electronic device; determine whether the operation trajectory of the operation body which is acquired through the sensor of the electronic device satisfies a first predetermined condition; generate the preview instruction for the new desktop theme when the operation trajectory satisfies the first predetermined condition; and determine whether the operation trajectory of the operation body which is acquired through the sensor of the electronic device satisfies a second predetermined condition, wherein the second predetermined condition is a condition that the operation body does riot leave the display screen on the basis that the first predetermined condition is satisfied.

Here, the first predetermined condition may be a condition that a specified sliding manner is performed in a specified region or the like.

It should be pointed out herein that if the operation body leaves before arriving at a specified position, the preview instruction is no longer performed, and the first identification picture for the icons is recovered at this time. In this way, when the user is not satisfied with the previewed new desktop theme, the preview operation may be stopped at any time. Then, another new desktop theme may be previewed again.

It is easily reached that in the process of implementing a specific embodiment, the processor may be a CPU, an MPU, a DSP, a FPGA or the like.

It should be pointed out herein that the apparatus embodiment above has similar description to that of the method embodiment above, has a similar beneficial effect to that of the method embodiment, and therefore will not be described. The technical details which are not disclosed in the apparatus embodiment of the present disclosure can be understood with reference to the description of the method embodiment of the present disclosure, and will not be described for brevity.

### Ninth Embodiment

Based on the above embodiments, the embodiment of the present disclosure further provides a display control apparatus that includes a display screen and a processor.

The display screen is configured to display a desktop interface.

The processor is configured to acquire an operation trajectory of an operation body through a sensor of an electronic device; determine whether the operation trajectory of the operation body which is acquired through the sensor of the electronic device satisfies a first predetermined condition; generate the preview instruction for the new desktop theme when the operation trajectory satisfies the first predetermined condition; determine whether the operation trajectory of the operation body which is acquired through the sensor of the electronic device satisfies a second predetermined condition, wherein the second predetermined condition is a condition that the operation body does not leave the display screen while the first predetermined condition is satisfied; determine, based on the operation trajectory of the operation body which is acquired through the sensor of the electronic device, a cancel instruction for cancelling preview of the new desktop theme, by: determining whether the operation trajectory satisfies a third predetermined condition; and generating the cancel instruction when the operation trajectory does not satisfy the third predetermined condition, wherein third predetermined condition is a condition that operation parameters generated by the operation body when the operation body leaves the display screen satisfy a particular condition while the first predetermined condition is satisfied; or

determine, based on the operation trajectory of the operation body which is acquired through the sensor of the electronic device, a change instruction for changing the old desktop theme to the new desktop theme for preview by: determining whether the operation trajectory satisfies the third predetermined condition; and generating the change instruction when the operation trajectory satisfies the third predetermined condition.

FIG. 9 illustrates a desktop interface in which an old desktop theme is changed to a new desktop theme. After a user comprehensively previews a display effect of changing the old desktop theme to the new desktop theme, if the user is satisfied with the display effect, the operation body of the user may leave from a particular region. In this way, the old desktop theme is directly changed to the new desktop theme, which is convenient for change of a desktop theme.

It is easily reached that in the process of implementing a specific embodiment, the processor may be a CPU, an MPU, a DSP, a FPGA or the like.

It should be pointed out herein that the apparatus embodiment above has similar description to that of the method embodiment above, has a similar beneficial effect to that of the method embodiment, and therefore will not be described. The technical details which are not disclosed in the apparatus embodiment of the present disclosure can be understood with reference to the description of the method embodiment of the present disclosure, and will not be described for brevity.

It should be understood that throughout the specification, the reference to “one embodiment” or “an embodiment” means that specific features, structures or properties related to the embodiment are included in at least one embodiment of the present disclosure. Therefore, “in one embodiment” or “in an embodiment” occurred in various positions throughout the specification may not necessarily refer to the same embodiment. Furthermore, these specific features, structures or properties may be combined into one or more embodiments in any appropriate manner. It should be understood that in various embodiments of the present disclosure, serial numbers of the above various processes do not means an order of performing these processes, which should be determined by functions and inherent logics thereof, and should not limit the implementations of the embodiments of the present disclosure in any way. The serial numbers of the above embodiments of the present disclosure are merely illustrative, instead of arranging the embodiments in terms of performance.

t should be illustrated that terms “comprise”, “include” and any other variations thereof herein are intended to cover non-exclusive including, so that a process, method, article, or apparatus including a series of elements not only comprises these elements, but also comprises other elements which are not explicitly listed, or comprises elements which are inherent to the process, method, article or apparatus. Unless otherwise indicated, an element defined by a phrase “comprising one . . . ” does not mean excluding a condition that a process, method, article or apparatus comprising the element further comprises other elements which are the same as the element.

It should be understood that the devices and methods disclosed in the embodiments of the present disclosure may be implemented in other manners. The device embodiments as described above are merely illustrative. For example, the division of the units is merely a logically functional division, and in practice, there may be other division manners. For example, multiple units or components may be combined or may be integrated into another system, or some features may be ignored or may not be implemented. In addition, various constituent parts, which are displayed or discussed as being coupled or communicatively connected directly, may also be coupled or communicatively connected indirectly via some interfaces, devices or units in an electrical manner, a mechanical manner, or other manners.

The above units described as separate components may be or may not be separated physically. The components displayed as units may be or may not be physical units, i.e., they may be located in a place or may also be distributed among multiple network units. A part or all of the units may be selected as needed to achieve the purpose of the solutions of the embodiments.

In addition, various functional units according to the embodiments of the present disclosure may all be integrated into a processing module, or various units may be used separately, or two or more units are integrated into a unit. The above integrated units may be implemented by hardware or by hardware and software functional units.

A person having ordinary skill in the art can understand that all or a part of steps for implementing the above method embodiments may be implemented by programs instructing related hardware. The programs above may be stored in a computer readable storage medium. When the programs are executed, the steps of the above method embodiments are implemented. The storage medium above may be a medium which can store program codes, such as a mobile storage device, a Read-Only Memory (ROM), a disk, or a disc etc.

Alternatively, the integrated unit according to the present disclosure may also be stored in a computer readable storage medium when it is implemented in a form of software functional module and is sold or used as an independent product. Based on this understanding, the substance of the technical solutions according to the embodiments of the present disclosure or portions of the technical solutions which contribute to the related art may be embodied in a form of software product. The computer software product is stored in a storage medium, including a number of instructions to enable a computer device (which may be a personal computer, a server, or a network device or the like) to perform all or a part of the methods according to various embodiments of the present disclosure. The storage medium described above may be a medium which can store program codes, such as a mobile storage device, a ROM, a disk, or a disc or the like.

The above description is merely specific embodiments of the present disclosure, and the scope of the present disclosure is not limited thereto. Changes or substitutions, which can be obviously envisaged by those skilled persons in the art, should be included in the scope of the present disclosure without departing the scope defined by the appended claims. Therefore, the protection scope of the present disclosure should be defined by the claims.

I/We claim:

1. A display control method, comprising:
acquiring a preview instruction for a new desktop theme; and
in response to the preview instruction,
acquiring a theme data package of the new desktop theme,
acquiring at least one icon carried on a desktop interface which is currently displayed on a display screen of an electronic device, and
temporarily changing, based on the theme data package of the new desktop theme, a body which carries the at least one icon from a first identification picture to a second identification picture.

2. The method according to claim 1, further comprising:
acquiring an operation trajectory of an operation body through a sensor of the electronic device; and
making a response to the preview instruction in real time based on the operation trajectory.

3. The method according to claim 2, wherein,
said acquiring at least one icon carried on a desktop interface which is currently displayed on a display screen of an electronic device comprises:
determining a preview region including the operation trajectory on the display screen based on the operation trajectory; and
acquiring a first portion of the desktop interface within the preview region on the display screen and an icon carried on the first portion; and
said temporarily changing, based on the theme data package of the new desktop theme, a body which carries the at least one icon from a first identification picture to a second identification picture comprises:
determining, based on the icon carried on the first portion, the second identification picture corresponding to the icon carried on the first portion from the theme data package; and
temporarily changing the first identification picture for the icon carried on the first portion to the second identification picture,
wherein the first portion of the desktop interface and the icon carried on the first portion have a preview display effect of the new desktop theme, and a second portion of the desktop interface except for the first portion and an icon carried on the second portion have a display effect of an old desktop theme which is different from the new desktop theme.

4. The method according to claim 3, wherein,
said acquiring a preview instruction for a new desktop theme comprises:
determining whether the operation trajectory of the operation body which is acquired through the sensor of the electronic device satisfies a first predetermined condition; and
generating the preview instruction for the new desktop theme when the operation trajectory satisfies the first predetermined condition; and
said making a response to the preview instruction in real time based on the operation trajectory comprises:
determining whether the operation trajectory of the operation body which is acquired through the sensor of the electronic device satisfies a second predetermined condition, wherein the second predetermined condition is a condition that the operation body does not leave the display screen while the first predetermined condition is satisfied,

5. The method according to claim 4, further comprising:
determining, based on the operation trajectory of the operation body which is acquired through the sensor of the electronic device, a cancel instruction for canceling preview of the new desktop theme by:
determining whether the operation trajectory satisfies a third predetermined condition; and
generating the cancel instruction when the operation trajectory does not satisfy the third predetermined condition, wherein third predetermined condition is a condition that an operation parameter generated by the operation body when the operation body leaves the display screen satisfies a particular condition while the first predetermined condition is satisfied; or
determining, based on the operation trajectory of the operation body which is acquired through the sensor of the electronic device, a change instruction for changing the old desktop theme to the new desktop theme for preview by:
determining whether the operation trajectory satisfies the third predetermined condition; and
generating the change instruction when the operation trajectory satisfies the third predetermined condition.

6. An electronic device comprising a display screen and a processor, wherein
the display screen is configured to display a desktop interface; and
the processor is configured to acquire a preview instruction for a new desktop theme, and in response to the preview instruction,
acquire a theme data package of the new desktop theme,
acquire at least one icon carried on a desktop interface which is currently displayed on the display screen of the electronic device, and
temporarily change, based on the theme data package of the new desktop theme, a body which carries the at least one icon from a first identification picture to a second identification picture.

7. The electronic device according to claim 6, wherein the processor is configured to
acquire an operation trajectory of an operation body through a sensor of the electronic device; and
make a response to the preview instruction in real time based on the operation trajectory.

8. The electronic device according to claim 7, wherein the processor is configured to
determine a preview region including the operation trajectory on the display screen based on the operation trajectory;
acquire a first portion of the corresponding desktop interface within the preview region on the display screen and an icon carried on the first portion; determine, based on the icons carried on the first portion, the second identification picture corresponding to the icon carried on the first portion from the theme data package; and
temporarily change the first identification picture for the icon carried on the first portion to the second identification picture,
wherein the first portion of the desktop interface and the icon carried on the first portion have a preview display effect of the new desktop theme, and a second portion of the desktop interface except for the first portion and an icon carried on the second portion have a display effect of an old desktop theme which is different from the new desktop theme.

9. The electronic device according to claim 8, wherein the processor is configured to
determine whether the operation trajectory of the operation body which is acquired through the sensor of the electronic device satisfies a first predetermined condition;
generate the preview instruction for the new desktop theme when the operation trajectory satisfies the first predetermined condition; and
determine whether the operation trajectory of the operation body which is acquired through the sensor of the electronic device satisfies a second predetermined condition,
wherein the second predetermined condition is a condition that the operation body does not leave the display screen while the first predetermined condition is satisfied.

10. The electronic device according to claim 9, wherein the processor is configured to
determine, based on the operation trajectory of the operation body which is acquired through the sensor of the electronic device, a cancel instruction for canceling preview of the new desktop theme by:
determining whether the operation trajectory satisfies a third predetermined condition; and
generating the cancel instruction when the operation trajectory does not satisfy the third predetermined condition,
wherein third predetermined condition is a condition that an operation parameter generated by the operation body when the operation body leaves the display screen satisfies a particular condition while the first predetermined condition is satisfied; or
determine, based on the operation trajectory of the operation body which is acquired through the sensor of the electronic device, a change instruction for changing the old desktop theme to the new desktop theme for preview by:
determining whether the operation trajectory satisfies the third predetermined condition; and
generating the change instruction when the operation trajectory satisfies the third predetermined condition.
